(19) United States
(12) Patent Application Publication
(10) Pub. No.: US 2015/0377401 A1
(43) Pub. Date: Dec. 31, 2015

(54) Coupler

(71) Applicant: DENGEN CO., LTD., Osaka (JP)

(72) Inventor: Issei Higami, Osaka (JP)

(73) Assignee: DENGEN CO., LTD., Osaka (JP)

(21) Appl. No.: 14/744,422

(22) Filed: Jun. 19, 2015

(30) Foreign Application Priority Data
Jun. 27, 2014 (JP) 2014-133379

(51) Int. Cl. F16L 55/07; F16L 55/09; F16L 35/00; F16L 15/08; F16L 33/22

(52) U.S. Cl. CPC F16L 55/07; F16L 15/08; F16L 33/22; F16L 35/00; F16L 55/09

(57) ABSTRACT

A coupler for connecting a hose of a refrigerant loading/recovery source to a linking part of a heating/cooling device, the linking part having a linking-part-side valve body; the coupler having a connecting part capable of connecting with the linking part of the heating/cooling device, a main shaft capable of pressing the linking-part-side valve body of the heating/cooling device, and a main shaft operating part for moving the main shaft forward and backward; restricting protuberances being provided to either a rear outside face of the connecting part or the main shaft operating part; and protuberance-guiding device for guiding the restricting protuberances being formed in the other one of the rear outside face of the connecting part and the main shaft operating part, along tracks that spiral around the center axis of the connecting part.

### BACKGROUND OF THE INVENTION

1. Field of the Invention

The present invention primarily relates to a coupler for connecting a refrigerant supply source for a heating/cooling device (e.g., an air conditioner or the like of an automobile), and a heating/cooling device.

2. Description of the Related Art

In general, to perform vacuum suction and refrigerant loading and recovery in a heating/cooling device such as an air conditioner or the like of an automobile, a refrigerant loading/recovery source is provided with a loading/recovery hose for connecting to the heating/cooling device. A coupler is provided at the distal end of the recovery hose. Vacuum suction and refrigerant loading and recovery in the heating/cooling device are performed by connecting the coupler with a linking part in the heating/cooling device.

A valve is provided inside the coupler in order to switch between opening and blocking a refrigerant gas channel in the coupler. A main shaft that is integrated with or that moves in conjunction with the valve is also inserted.

With the coupler and the linking part linked, the valve in the coupler is opened by moving the main shaft. Means for moving the main shaft in order to open the valve include couplers of various configurations.

For example, a conventional example of a coupler in which a main shaft is moved by a cam and a large lever (valve-operating body) is provided to the cam is a pipe joint (e.g. see Patent Document 1) having a socket (coupler) and a plug that join together, the pipe joint being characterized in that: the socket (coupler) is provided with a tubular socket main body open at one end into which the plug is inserted and fitted, an opening/closing valve mounted inside the socket main body, valve-operating means for opening and closing the opening/closing valve, and connection-operating means for connecting or disconnecting the socket and the plug; the socket main body has a connection port provided to the one end and allowing the plug to be inserted therein, a fluid passageway formed along the axial direction of the socket main body from the connection port, and a pipe-connecting means in which is formed a fluid-channeling hole communicating with the fluid passageway along the diameter direction of the socket main body; the opening/closing valve has a rod-shaped valve shaft provided so as to be capable of advancing and retracting along the axial direction between a valve-open position and a valve-closed position within the fluid passageway, a first valve body which is attached to a peripheral wall of the valve shaft on the connection port side and which advances and retracts along the axial direction together with the valve shaft, a second valve body which is free to advance and retract within the fluid passageway along the axial direction so as to come in contact with or separate from the first valve body to close or open the fluid passageway, and which abuts on the distal end of the plug to be impeded from moving towards contact with the first valve body when the plug is fully inserted into the connection port, and a first elastic member for applying force causing the second valve body to move towards contact with the first valve body; the valve-operating means has a valve-operating member provided to the other end of the socket main body and capable of displacement so as to advance or retract the valve shaft along the axial direction between the valve-open position and the valve-closed position, and a second elastic member for applying greater force than the first elastic member so as to move the valve shaft towards abutment on the valve-operating member and to move the first valve body towards contact with the second valve body; and the connection-operating means has an engaging body provided to the peripheral wall of the connection port and supported on the socket main body while engaged in a disengagable manner with the plug inserted into the connection port, and an annular connection-operating member provided to the outer periphery of the peripheral wall of the connection port and displaced between a connection-holding position of keeping the engaging body pressed in the state of engagement with the plug and a connection-releasing position of separating the engaging body from the state of engagement with the plug.

A conventional example of a coupler in which a male screw is formed in the outer periphery of an end of a coupler main body, a valve-operating body having a female thread that is threaded on the male screw in a tubular-body inner surface is provided, and a main shaft is moved while the valve-operating body is continuously rotated about an axial center, is, e.g., a service adapter (e.g. see Patent Document 2) for connecting refrigerant from a supply source to a refrigeration device having an inlet coupling, the service adapter comprising: (a) a main body portion having a middle passageway extending along an axis line from an adjustment end to an outlet end, and a lateral port which is for refrigerant from the supply source and which is positioned between the adjustment end communicating with the middle passageway and the outlet end, the middle passageway of the main body portion having a first cylindrical portion between the adjustment end and the lateral port and a second cylindrical portion between the lateral port and the outlet end; (b) an axially movable operating shaft in the middle passageway extending from a first end positioned between the lateral port and the outlet end to a second end in the area of the adjustment end, the operating shaft including a sealing member that can be slideably engaged with the first cylindrical portion and a sealing gasket in the arear between the first end and the lateral port; (c) a first sleeve member capable of axially moving within the second cylindrical portion, the first sleeve member having (i) an inlet end, (ii) an outlet end, (iii) a sealing member sealingly engaged in a slideable manner with the second cylindrical portion, and (iv) an annular abutment member sized and positioned to be able to sealingly engage with the sealing gasket; (d) a first spring for bendingly urging the first sleeve member toward the outlet end; (e) a second sleeve member capable of axially moving within the second cylindrical portion, positioned between the first sleeve member and the outlet end, and having (i) an inlet end, (ii) an outlet end, (iii) an annular sealing member that outwardly faces the second cylindrical portion and slideably engages with the second cylindrical portion, and (iv) an inwardly facing annular sealing member; (f) a second spring for bendingly urging the second sleeve member axially away from the first sleeve member; (g) a connector for releaseably engaging the service adapter with an inlet coupling sized to be inserted into the second cylindrical portion, the inlet coupling having (i) an end face encircling an opening, (ii) an abutment member capable of engaging with the outlet end of the second sleeve member, and (iii) a valve capable of engaging with the first end of the operating shaft and moving axially, and the connector axially moving the second sleeve member toward the first sleeve member when the inlet coupling is inserted into the second cylindrical portion; and (h) an actuator for moving the operating shaft axially from a rearward position toward the adjustment end to a forward position toward the outlet end, the axial movement causing the sealing gasket to disengage from the annular abutment member of the first sleeve member after the abutting engagement between the first sleeve member and the first sleeve member.

### PRIOR ARTS LIST

Patent Document 1: Japanese Laid-open Patent Publication No. 2012-241792

Patent Document 2: Japanese Patent No. 3178842

### SUMMARY OF THE INVENTION

The coupler according to Patent Document 1 described above has a large lever (valve-operating body) provided to a cam, and the lever is therefore seemingly easy to operate. However, the interiors of automobile engine compartments are recently growing smaller, and the piping layouts of air conditioners and the like are often strict. Therefore, the lever operation tends to be obstructed by pipes, which is a problem in that operation is made more difficult.

In the coupler according to Patent Document 2 described above, the valve-operating body is rotatably moved along the male screw, and the coupler is thought to be suitable for installation in an engine compartment due to taking up less space than the valve-operating body according to Patent Document 1 described above. However, due to the above-described strictness of the piping layouts of air conditioners and the like, the position of the linking part of the heating/cooling device linked with the coupler is often in a location where a worker's hands will not easily fit. In such cases, the operation of continuously rotating the valve-operating body involves reinserting the fingers many times into a location where the fingers will not easily fit to readjust and rotate the valve-operating body, which is extremely inconvenient.

Furthermore, a drawback of continuous rotation by threading is that it is difficult to perceive the amount by which the valve-operating body is pressed in.

A possible solution here is to mark graduations as appropriate in order to perceive the pressed amount from the exterior.

However, because of an insufficiently lit environment or the relationship of the piping layout, it is not necessarily possible to accurately perceive the position of the valve-operating body from the front face of the graduations.

The present invention, was devised in view of the circumstances described above, and the invention is intended to solve the problem of providing a coupler whereby a refrigerant supply source and the heating/cooling device can be easily connected and disconnected with a smooth operation inside an automobile engine compartment or the like which has been reduced in size.

The means for solving this problem in the present invention is a coupler for connecting a hose of a refrigerant loading/recovery source to a linking part in a heating/cooling device, the linking part having a linking-part-side valve body, the coupler comprising a connecting part capable of connecting at least with the linking part of the heating/cooling device, a main shaft capable of pressing the linking-part-side valve body of the heating/cooling device, and a main shaft operating part for moving the main shaft forward and backward; the coupler characterized in that: restricting protuberances are provided to either a rear outside face of the connecting part or the main shaft operating part; protuberance-guiding means for guiding the restricting protuberances are formed in the other one of the rear outside face of the connecting part and the main shaft operating part, along tracks that spiral around the center axis of the connecting part; and the restricting protuberances are capable of moving within the protuberance-guiding means in a range of approximately 90° (approximately one fourth of a rotation) or less in a rear view about the center axis of the connecting part, and the main shaft operating part can be actuated relative to the connecting part within the same range of approximately 90°.

Another means for solving this problem in the present invention is a coupler for connecting a hose of a refrigerant loading/recovery source to a linking part in a heating/cooling device, the linking part having a linking-part-side valve body, the coupler comprising a connecting part capable of connecting at least with the linking part of the heating/cooling device, a main shaft capable of pressing the linking-part-side valve body of the heating/cooling device, and a main shaft operating part for moving the main shaft forward and backward; the coupler characterized in that: restricting protuberances are provided to either a rear outside face of the connecting part or the main shaft operating part; protuberance-guiding means for guiding the restricting protuberances are formed in the other one of the rear outside face of the connecting part and the main shaft operating part, along tracks that spiral around the center axis of the connecting part; and the restricting protuberances are capable of moving within the protuberance-guiding means in a range of approximately 90° or less in a rear view about the center axis of the connecting part, the main shaft operating part can be actuated relative to the connecting part within the same range of approximately 90° or less, interlocking parts are formed in open-side ends of the protuberance-guiding means so as to expand the groove width rearward, the restricting protuberances are configured to interlock with the interlocking parts, and a collision noise and shock accompanies the interlocking of the restricting protuberances and the interlocking parts.

Another means for solving this problem in the present invention is a coupler premised on the configuration of either invention described above, and characterized in being provided with a connecting chamber guidance member and a lock control member with which the main shaft communicates in the connecting space of the connecting part, the lock control member being placed toward the front, the connecting chamber guidance member being placed toward the rear, a second spring member being provided therebetween, and, while the main shaft operating part is moved from the open state of the coupler to the blocked state, the retracting of the main shaft which moves in conjunction and the elastic force of the second spring member forming a gap between the lock control member and the connecting chamber guidance member and allowing residual gas in the connecting space to be expelled to the exterior.

In the present invention, restricting protuberances are provided to either the rear outside face of the connecting part or the main shaft operating part; protuberance-guiding means for guiding the restricting protuberances are formed in the other one of the rear outside face of the connecting part and the main shaft operating part, along tracks that spiral around the center axis of the connecting part; and the restricting protuberances are capable of moving within the protuberance-guiding means in a range of approximately 90° or less in a rear view about the center axis of the connecting part, and the main shaft operating part can be actuated relative to the connecting part within the same range of approximately 90° or less. Therefore, interference with the piping or the like is greatly reduced in an automobile engine compartment or the like that has a strict piping layout or the like and that has been reduced in size, the main shaft can be operated merely by taking hold of and rotating the main shaft operating part by an angle of 90° or less, past troubles can therefore be resolved, which were that the valve-operating body had to be readjusted and rotated by reinserting the fingers many times in locations such as those where fingers did not easily fit, and the coupler and the linking part of the heating/cooling device can easily be connected and disconnected with a smooth operation.

In the invention according to the second aspect, which is premised on the configuration of the invention described above, interlocking parts are formed in open-side ends of the protuberance-guiding means so as to expand the groove width rearward, the restricting protuberances are configured to interlock with the interlocking parts, and a collision noise and shock accompanies the interlocking of the restricting protuberances and the interlocking parts whereby the operational effects of the invention described above are achieved, and in addition, a collision noise and shock are transferred to the worker during the interlocking of the restricting protuberances and the interlocking parts, whereby the worker can confirm the open state (the “open” position).

Due to this configuration, because the interlocking parts are formed, force is needed to bring the main shaft operating part over and past the interlocking parts when the main shaft operating part is turned from the open state (the “open” position) to the blocked state (the “closed” position), and errors when selecting between “open” and “closed” can therefore be prevented.

In the invention according to the third aspect, which is premised on the configurations of the inventions described above, the coupler is provided with a connecting chamber guidance member and a lock control member through which the main shaft communicates with the connecting space of the connecting part, the lock control member is placed toward the front, the connecting chamber guidance member is placed toward the rear, a second spring member is provided therebetween, and, while the main shaft operating part is moved from the open state of the coupler to the blocked state, the retracting of the main shaft which moves in conjunction and the elastic force of the second spring member forms a gap between the lock control member and the connecting chamber guidance member and allows residual gas in the connecting space to be expelled to the exterior; therefore, in addition to achieving the operational effects of either invention described above, it is possible to provide a coupler whereby high-pressure states in the coupler caused by residual gas are suppressed when the coupler is removed from the linking part, and the coupler can be easily connected and disconnected with a smooth operation.

### BRIEF DESCRIPTION OF THE DRAWINGS

FIG. 1A is a perspective view showing the flat face, right-side face, and rear face, and FIG. 1B is a perspective view showing the flat face, left-side face, and rear face, in a partially exploded state of a coupler according to an embodiment of the present invention;

FIG. 2 is a right-side face view showing the coupler and linking part according to an embodiment of the present invention;

FIG. 3 is a right-side face view showing the linking member as being inserted into the coupler according to an embodiment of the present invention;

FIG. 4 is a partial longitudinal cross-sectional view of the linking member as being inserted into the coupler according to an embodiment of the present invention;

FIG. 5 is a partial longitudinal cross-sectional view of a state in which the linking member has been inserted into the coupler according to an embodiment of the present invention, the main shaft operating part has been rotated 90°, and gas has been loaded;

FIG. 6 is a partial longitudinal cross-sectional view showing a state in which the main shaft operating part has been returned 45° from the gas-loaded state in the coupler according to an embodiment of the present invention;

FIG. 7 is a partial longitudinal cross-sectional view showing a state in which the main shaft operating part has been further returned from the state of FIG. 6, and residual gas is expelled in the coupler according to an embodiment of the present invention; and

FIG. 8A and FIG. 8B are perspective views showing a partial exploded state in a coupler according to another embodiment of the present invention.

### DESCRIPTION OF THE PREFERRED EMBODIMENTS

The present invention succeeds in providing a superior coupler for connecting a hose of a refrigerant loading/recovery source to a linking part in a heating/cooling device, the linking part having a linking-part-side valve body, the coupler comprising a connecting part capable of connecting at least with the linking part of the heating/cooling device, a main shaft capable of pressing the linking-part-side valve body of the heating/cooling device, and a main shaft operating part for moving the main shaft forward and backward; wherein the coupler has a configuration in which guide grooves, which are protuberance-guiding means along tracks spiraling around a center axis of the connecting part, are formed in the rear outside face of the connecting part in a range of approximately 90° in a rear view about the center axis, the main shaft operating part has a cylindrical shape covering at least part of the rear outside face of the connecting part and is provided with restricting protuberances that protrude inward from the inner peripheral surface thereof, the restricting protuberances can be fitted into the guide grooves to move the main shaft operating part in a range of approximately 90°, recessed parts in the form of interlocking parts are formed in the open-side ends of the guide grooves so as to expand the groove width rearward, and the restricting protuberances interlock with the recessed parts; therefore, interference with the piping or the like is greatly reduced in an automobile engine compartment or the like that has a strict piping layout or the like and that has been reduced in size, the main shaft can be operated merely by taking hold of and rotating the main shaft operating part by 90°, past troubles can therefore be resolved, which were that the valve-operating body had to be readjusted and rotated by reinserting the fingers many times in locations such as those where fingers did not easily fit, and the coupler and the linking part of the heating/cooling device can easily be connected and disconnected with a smooth operation; and due to the configuration in which recessed parts are formed in the open-side ends of the guide grooves so as to expand the groove width rearward and the restricting protuberances are interlocked with the recessed parts, a collision noise and vibration or even shock are produced when the restricting protuberances and the recessed parts interlock, and the worker can confirm the open state.

### Embodiments

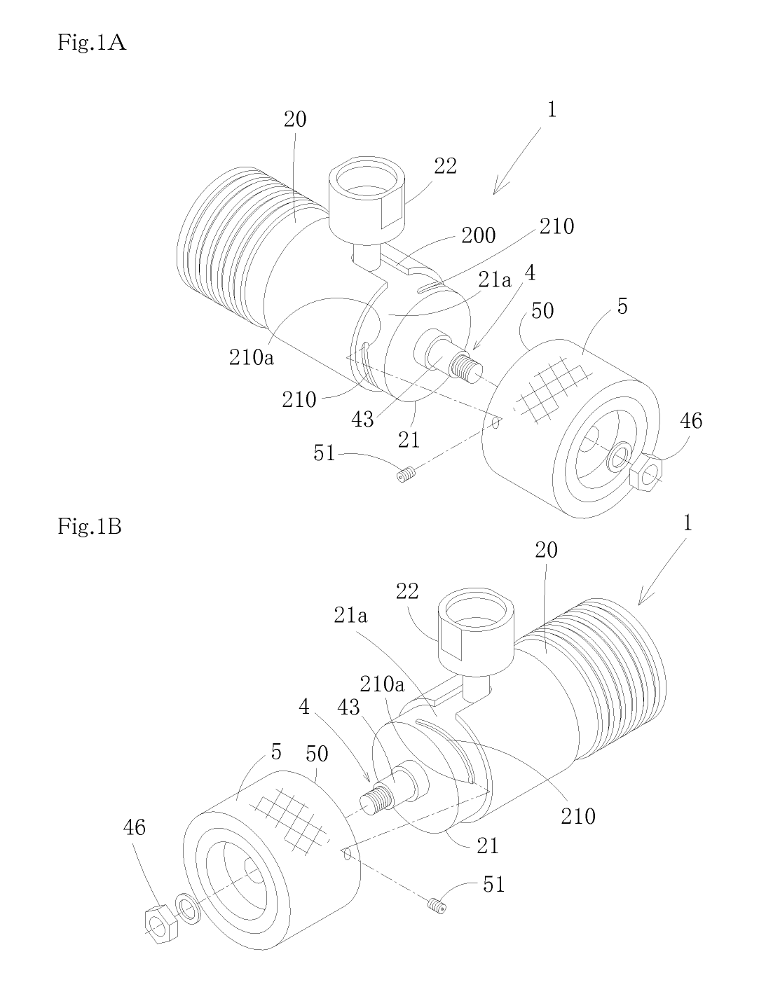

A coupler 1 according to an embodiment of the present invention is described below. The present invention is not limited to the following embodiment. The characteristics of the present invention are in the structure of the main shaft operating part 5 or the connecting part 21 operated together with the main shaft operating part 5 disclosed in FIG. 1A in particular as shown above, and for the mechanisms for opening and closing or otherwise manipulating the other channels, various conventional configurations can be applied instead of those shown in the embodiments.

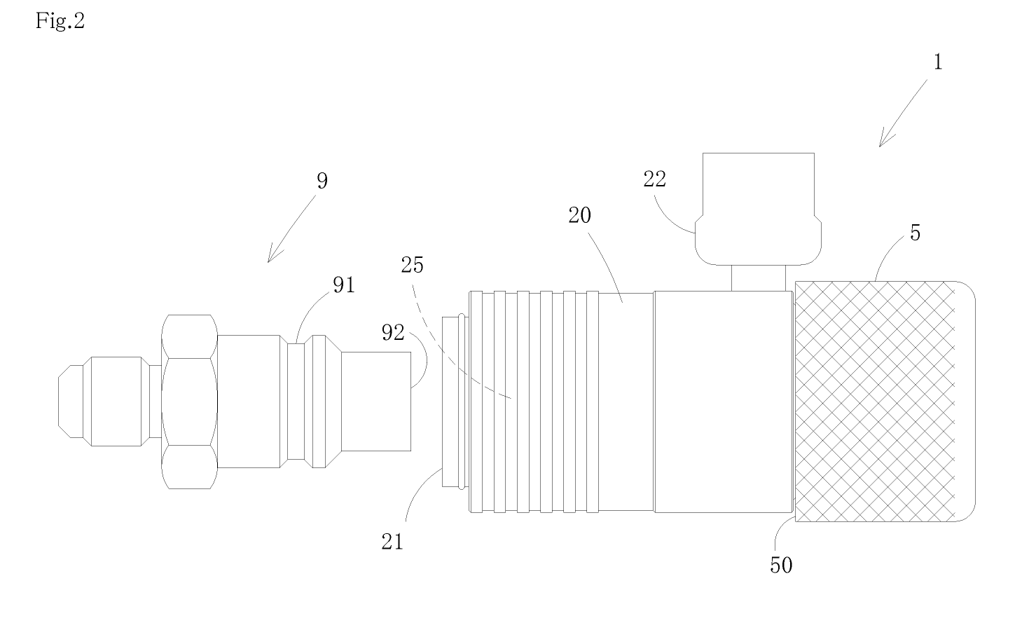

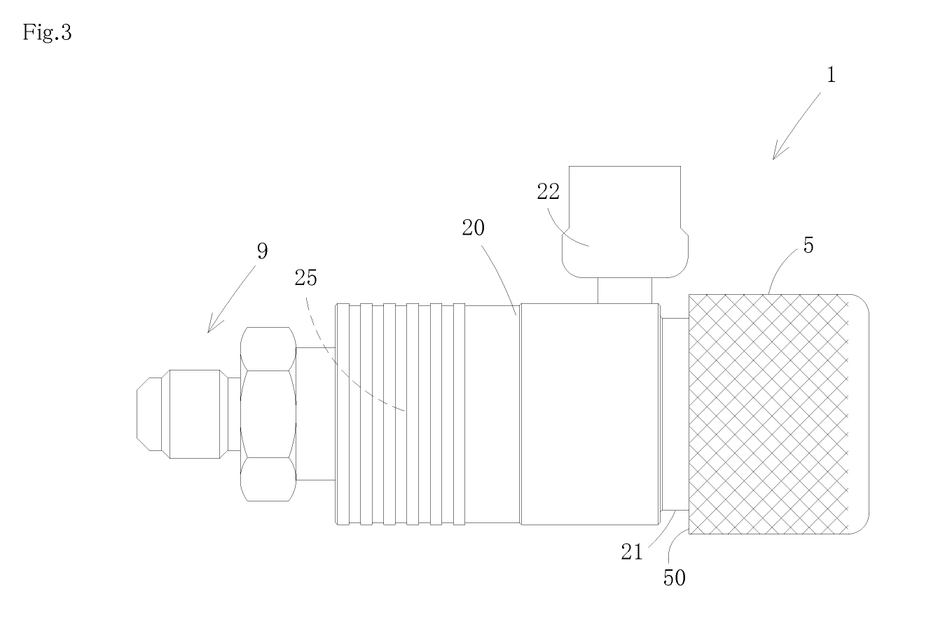

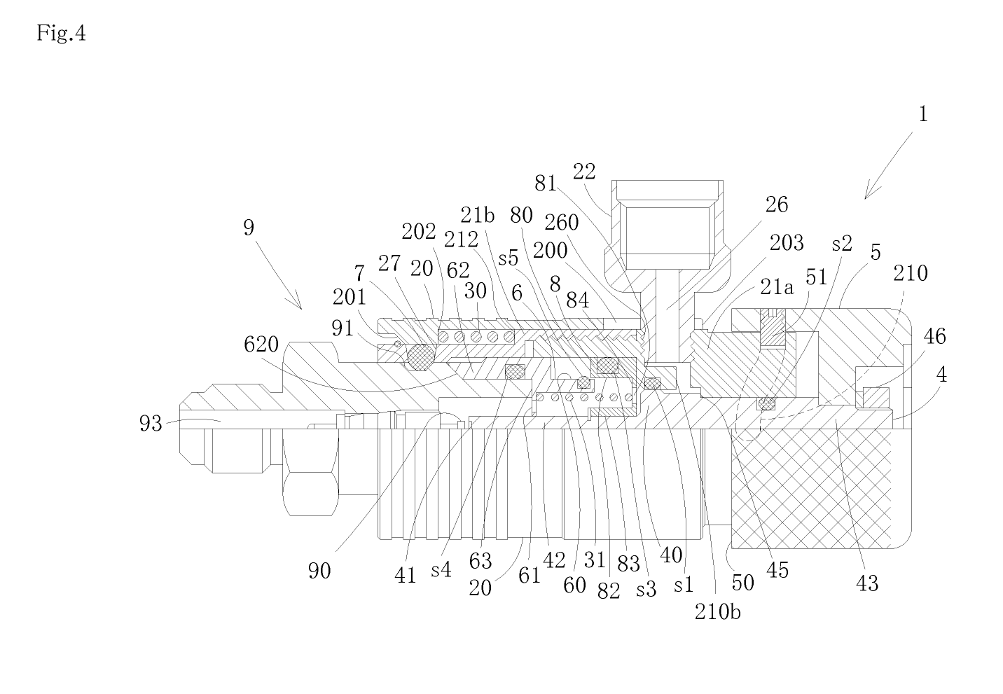

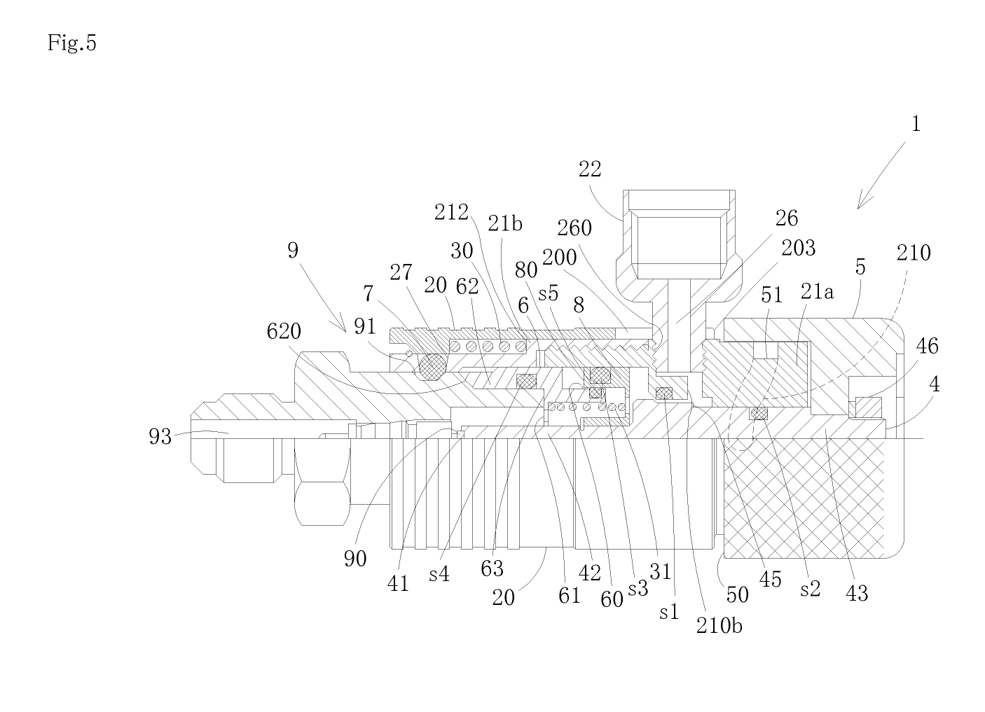

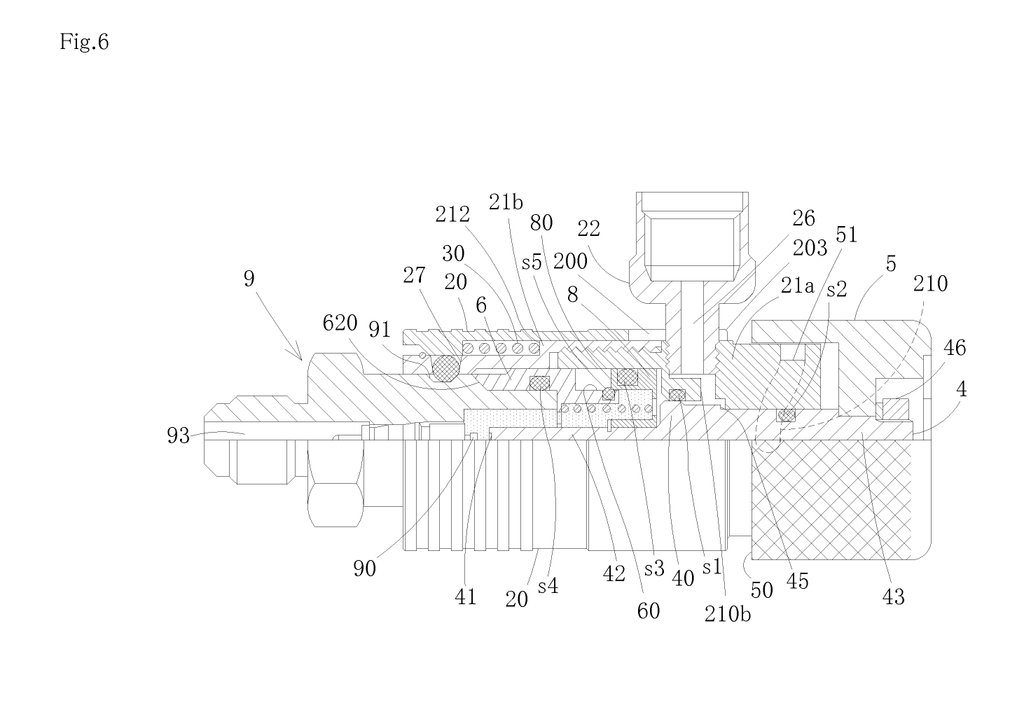

The coupler 1 according to the embodiment of the present invention is provided with a connecting part 21 having a substantially cylindrical outward appearance, a main shaft 4 disposed in the center axis of the connecting part 21 and protruding rearward from the rear part of the connecting part 21, a main shaft operating part 5 attached to the main shaft 4, a hose connecting part 22 attached to the side surface of the connecting part 21, a sleeve 20 provided to the outer periphery of the connecting part 21, and a lock control member 6 and connecting chamber guidance member 8 stored inside the connecting part 21; a first spring member 30 (a coil spring) being provided between the sleeve 20 and the connecting part 21, and a second spring member 31 (a coil spring) being provided between the lock control member 6 and the connecting chamber guidance member 8, as shown in FIGS. 1 through 7.

A linking part 9 in an air conditioner or another heating/cooling device connecting the coupler 1 is configured as a tube, in the outside surface of which is formed a locking groove part 91 corresponding to a lock member 7 of the coupler 1. A linking-part-side valve body 90, which is a “valve core,” is provided inside the linking part 9. The linking-part-side valve body 90 is pressed against the main shaft 4 in the coupler 1, whereby the linking-part-side valve body 90 of the inlet linking part 9 opens, and an inlet-linking-part-side passageway 93 is opened, which is a channel inside the inlet linking part 9.

The connecting part 21 is provided with a first connecting part 21a and a second connecting part 21b. The first connecting part 21a and the second connecting part 21b are cylindrical shapes that can be screwed together. To make assembly more convenient, the connecting part can be divided into the first connecting part 21a and the second connecting part 21b, and is operated with the two parts functionally integrated.

The first connecting part 21a is provided with a main shaft guiding part 23 for passing the main shaft 4 through into the interior, a connecting space 25 continuing forward from the main shaft 4 guiding part 23, and a valve-forming part 210b which together with an enlarged-diameter valve body 40 forms an opening/closing valve for a channel leading to the hose connecting part 22. A concavity is formed in the inner surface of the valve-forming part 210b, and a first seal member s1 is fitted therein. The main shaft guiding part 23 opens in the rear surface of the connecting part 21, and the connecting space 25 opens in the front surface of the connecting part. Also provided is a side passageway 26 continuing from the connecting space 25 into the hose connecting part 22. From the opening of the side passageway 26 to a predetermined depth is a female thread part 260 for linking the hose connecting part 22.

In the side surface of the rear end side of the first connecting part 21a, guide grooves 210 are provided in a spiral direction, each over a range of 90° centered about the center axis in a rear surface view. The guide grooves 210 are provided in two locations aligned with positions in point symmetry about the center axis in a rear surface view.

Inside the ends of the guide grooves 210, in the sides where restricting protuberances 51 are positioned when the channels are opened, recessed parts 210a are formed by enlarging and deforming the tip contours of the guide grooves 210. A male thread that screws together with the second connecting part 21b is formed in the external peripheral surface in the front side of the first connecting part 21a.

The second connecting part 21b has a reduced-diameter step part 212 in a longitudinal middle position in the outer surface, and a female thread is provided in the inner surface on the rear side. A lock member hole 27 for holding the lock member 7 is provided in the front side.

The sleeve 20 is provided as abutting on the outer surface of the connecting part 21. The sleeve 20 is for maintaining engagement with the lock member 7 and the linking part 9, and also for releasing the engagement.

The front-end inner edge of the sleeve 20 has a tapered part 201 for guiding the lock member 7, which is spherical, and the inner surface of the sleeve 20 has a sleeve step part 202. The sleeve 20 is also provided with a notched part 200 that opens in the rear end, for preventing interference with the hose connecting part 22 when the sleeve moves forward and backward.

A space is formed between the connecting part 21 and the sleeve 20 by the sleeve step part 202 of the sleeve 20 and the reduced-diameter step part 212 of the second connecting part 21b. This space houses the first spring member 30 for urging the sleeve 20 forward.

The main shaft 4 is provided with: a valve body pressing part 41 at the distal end for pressing the linking-part-side valve body 90 of the linking part 9; a distal-end-side barrel part 42 through which the lock control member 6 communicates, the second spring member 31, and the connecting chamber guidance member 8; the enlarged-diameter valve body 40; a reduced-diameter step part 45; and a main shaft linking part 43 protruding rearward from the connecting part 21 and linked with the main shaft operating part 5. The enlarged-diameter valve body 40 functions as a valve which together with the second connecting part 21b can close off the channel. The reduced-diameter step part 45 of the main shaft 4 is formed larger than the opening of the main shaft guiding part 23, and the reduced-diameter step part 45 abuts on the opening of the main shaft guiding part 23, thereby also providing the functions of stopping the main shaft 4 from falling out to the rear and limiting the moveable range of the enlarged-diameter valve body 40. A circumferential concavity is formed in position in the rear end side of the main shaft 4 that slides with the connecting part 21, and a second seal member s2 is fitted therein.

The connecting chamber guidance member 8 is provided with a cylindrical main shaft insertion part 83 in the middle of a circular base plate 84, provided in the peripheral edge are an ring which is a third seal member s3 and a second circumferential holding frame part 80 for holding the 0 ring, and the circular base plate 84 is provided with a second aeration through-hole 81 as an aeration part passing through the front and back surfaces thereof. The connecting chamber guidance member 8 is fixed to the proximal end side in the distal-end-side barrel part 42 of the main shaft 4, i.e. to a position in proximity to the front end of the enlarged-diameter valve body 40. The guidance member is capable of moving forward and backward together with the main shaft 4, along the inner wall of the connecting space 25.

The lock control member 6 has a configuration in which a cylindrical wall 62 is erected forward in the peripheral edge of a circular plate 63, an inner groove part is formed in the inner surface of the cylindrical wall 62 with a fourth seal member s4 fitted therein, and a first circumferential holding frame part 60 for holding a fifth seal member s5 is formed in the rear surface of the circular plate 63, rearward from a position substantially in the middle of the diameter.

A first aeration through-hole 61 is formed in the circular plate 63, as an aeration part passing through the front and rear surfaces thereof. The front-end edge part of the cylindrical wall 62 is formed as a tapered surface 620 inclined toward the inner surface. The cylindrical wall 62 makes it possible for the lock member hole 27 opening in the connecting space 25 to be closed, whereby the lock member 7 can be moved outward and the sleeve 20 can be secured.

The inner surface of the cylindrical wall 62 guides the second spring member 31. The second spring member 31 is disposed centered around the same axis as the main shaft 4, the front end being in contact with the lock control member 6, and the rear end abutting on the connecting chamber guidance member 8.

An inner surface 82 of an upright wall of the second circumferential holding frame part 80 in the connecting chamber guidance member 8 and the fifth seal member s5 held in the first circumferential holding frame part 60 in the lock control member 6 are disposed so as to be capable of abutting, and a valve mechanism that can be opened and closed is configured by the inner surface 82 of the upright wall and the fifth seal member s5. The valve mechanism is used in order to expel residual gas, as is described hereinafter.

The main shaft operating part 5 according to the present embodiment is a cylindrical member attached to the main shaft 4, the diameter thereof being greater than the diameter of the connecting part 21, and the front-end edge part 50 of the main shaft operating part 5 being disposed so as to be capable of abutting on the sleeve rear end 203.

The restricting protuberances 51, which protrude toward the inner surface, are attached in two locations which oppose each other in the side wall of the main shaft operating part 5. The restricting protuberances 51 are fitted into the guide grooves 210.

The following is a description of the action during usage of the coupler 1 according to the embodiment having the configuration described above.

When the coupler 1 is fully closed and a hose (not shown) is connected to the hose connecting part 22, a distal end 92 of the linking part 9 is fitted into the connecting space 25 of the coupler 1 according to this embodiment.

The lock control member 6 in the connecting space 25 abuts on the distal end 92 of the linking part 9, and moves rearward against the spring elastic force of the second spring member 31 as the linking part 9 advances.

The retracting of the lock control member 6 causes the lock member 7, which is securing the sleeve 20 in the connecting part 21, to move into the connecting part 21 and enter the locking groove part 91 of the linking part 9.

The lock of the sleeve 20 is thereby released. The sleeve 20, released from the lock, is moved forward by the elastic force of the first spring member 30. In this step, the main shaft 4 does not move, and the channel remains closed.

Next, the main shaft operating part 5 is rotated to the right about the main shaft 4 as a reference, and the main shaft operating part 5 and the main shaft 4 are moved forward. When the main shaft operating part 5 is rotated, the main shaft operating part 5 rotates and moves forward along the guide grooves 210 disposed in a spiral formation in a range of 90° in a rear view.

The restricting protuberances 51 fit into the recessed parts 210a of the guide grooves 210, whereby a collision sound like a “plunk” is heard as the shock is transferred to the worker's hand, and the rotation action ends.

The connecting chamber guidance member 8 is also driven forward with the main shaft 4 at this time. In this state, the sleeve 20 is impeded by the main shaft operating part 5 from moving rearward because the main shaft operating part 5 is in proximity.

The valve mechanism is opened by the enlarged-diameter valve body 40 of the main shaft 4 moving forward, and the entire channel is opened by the distal end of the main shaft 4 pressing the linking-part-side valve body 90 of the linking part 9 and the inlet-linking-part-side passageway 93 being opened.

Next is a description of the procedure of removing the coupler 1 after refrigerant has been loaded and recovered.

First, the main shaft operating part 5 is turned 90° to the left by a reverse procedure in order to move the main shaft operating part 5 rearward.

At this time, the restricting protuberances 51 fit into the recessed parts 210a of the guide grooves 210, and the main shaft operating part 5 can therefore be turned by applying a load to move the protuberances over and past the recessed parts.

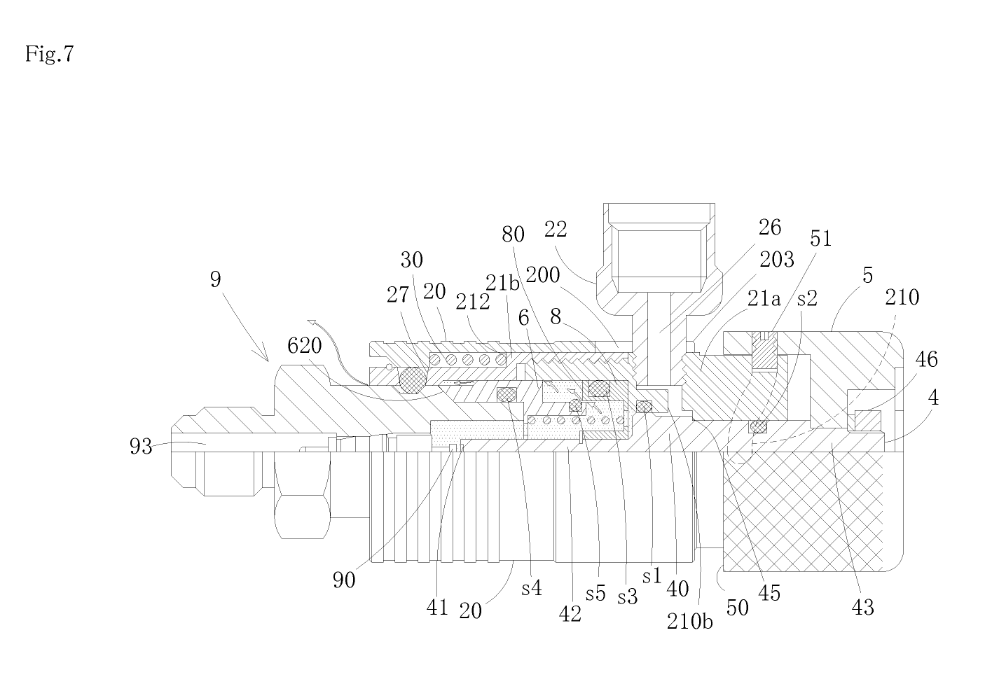

In the operation of turning the main shaft operating part 5 to the left, when the operating part has been turned 45°, the fifth seal member s5 provided to the rear-end side of the lock control member 6 and the distal-end side of the connecting chamber guidance member 8 firmly adhere together as shown in FIG. 7, and the residual gas is sealed in the connecting space 25. Further turning the main shaft operating part 5 to the left from this state causes the main shaft 4 to retract, and the lock control member 6 and the connecting chamber guidance member 8 are separated by the spring elasticity of the second spring member 31. The residual gas sealed in the connecting space 25 passes through a gap between the lock control member 6 and the connecting chamber guidance member 8, the gas passes between the connecting part 21 and the linking part 9, and the gas is emitted to the exterior, as shown by the arrow in FIG. 7. The pressure in the coupler 1 can thereby be reduced, and the coupler 1 and the linking part 9 can be easily disconnected.

Turning the main shaft operating part 5 to the left 90° and causing the part to retract creates a gap between the sleeve 20 and the main shaft operating part 5 and enables the sleeve 20 to retract. Due to the retracting of the sleeve 20, the lock member 7 can move to the outside of the connecting space 25 and the linking part 9 can be disconnected from the connecting space 25.

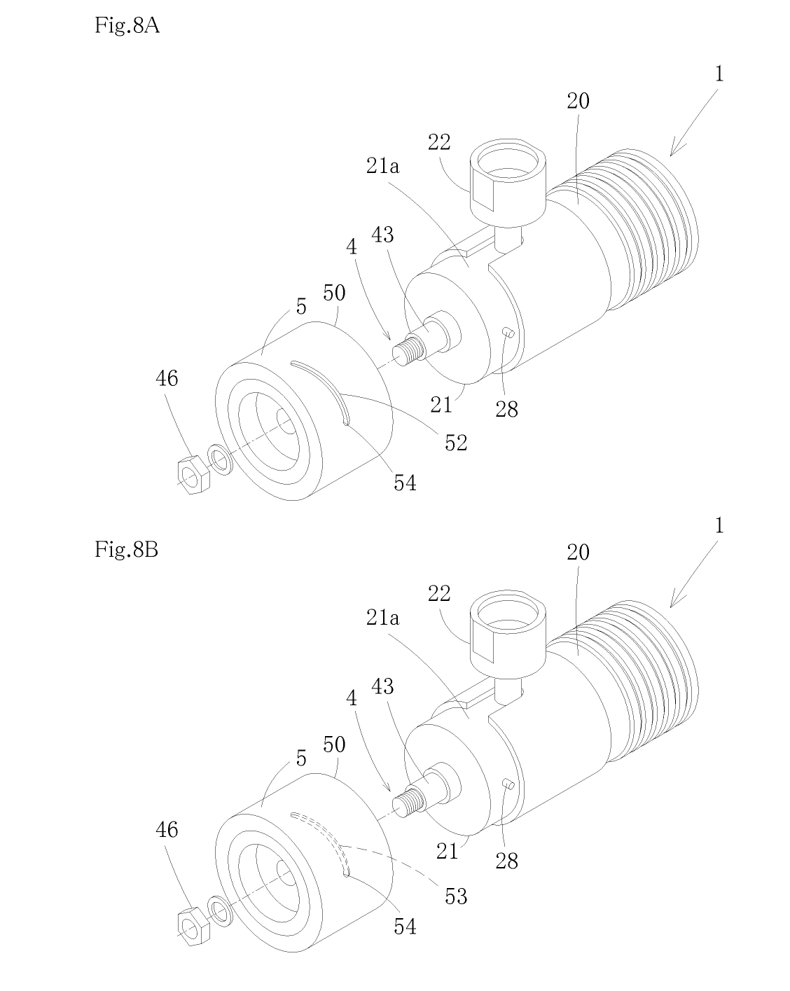

In the present invention, e.g., in the configuration of the above-described Embodiment 1, restricting protuberances 28 are provided in the side of the coupler 1 having the connecting part 21, and a guide hole 52 (see FIG. 8(a)) and a guide groove 53 (see FIG. 8(b)) as protuberance-guiding means can be provided in the side having the main shaft operating part 5.

The guide hole 52 is provided through the peripheral wall of the main shaft operating part 5, and the guide groove 53 is provided as a concavity opening in the inner-surface side without passing through the peripheral wall of the main shaft operating part 5.

In such a case, interlocking parts 54 are formed in the open-side end of the protuberance-guiding means so as to extend the groove width rearward, the restricting protuberances 28 are configured to interlock with the interlocking parts 54, and the configuration can be designed to produce a collision sound and shock accompanying the interlocking of the restricting protuberances 28 and the interlocking parts 54.

According to the present invention, the protuberance-guiding means and the restricting protuberances 51 are not limited to being provided to the two locations shown in Embodiment 1; each may be provided to only one location, or they can be provided to three or more locations. The present invention also includes cases of no recessed parts 210a as interlocking parts, but forming a recessed part 210a in at least one location of the protuberance-guiding means is very advantageous in that a collision sound and shock can be produced and the worker can confirm the open state (the “open” position) when the restricting protuberances 51 and the guide grooves 210 interlock as described above.

The interlocking parts in the present invention may have a shape other than that of the recessed parts 210a shown in the embodiment, and the interlocking parts may be configured so that the width of the guide grooves is partially narrowed, or they may have another configuration in which restricting protuberances are interlocked with guide grooves and the shock from the interlocking is transmitted to the user.

The restricting protuberances are not limited to having the screw shapes shown in Embodiment 1; they may be pins or protuberances formed by machining pins, the shapes of which can be decided as appropriate within the range of the design matters.

The configurative members are not limited to the shapes, positions, sizes, ratios, and other characteristics shown in the above embodiment; they can be modified in various ways within a range that does not impede the functions thereof, including the application of various conventionally known features.

In the above embodiment, the main shaft operating part 5 was turned by 90°, but it can also be turned by approximately 90° or less. The turning angle can be decided by setting parameters such as the length of the main shaft 4, the stroke, and the angle of inclination of the protuberance-guiding means. When the main shaft operating part 5 is turned past approximately 90° to an obtuse angle, the turning operation becomes difficult to perform because the main shaft operating part 5 must be turned over pipes and the like having orthogonal angles within the engine compartment, and the main shaft operating part 5 must be turned up to approximately 90°. When the turning angle is extremely small, an erroneous operation is likely, and given the degree of freedom with the thumb and forefinger when the main shaft operating part 5 is grasped between the thumb and forefinger, a sufficiently recognizable range of roughly 45° (approximately one eighth of a rotation) to approximately 90° (approximately one fourth of a rotation) is considered to be suitable for a common turn.

### KEY

1: coupler
20: sleeve
200: notched part
201: tapered part
202: sleeve step part
203: sleeve rear end
21: connecting part
21a: first connecting part
21b: second connecting part
210: guide grooves
210a: recessed parts
210b: valve-forming part
212: reduced-diameter step part
22: hose connecting part
25: connecting space
26: side passageway
260: female thread part
27: lock member hole
28: restricting protuberances
30: first spring member
31: second spring member
4: main shaft
40: enlarged-diameter valve body
41: valve body pressing part
42: distal-end-side barrel part
43: main shaft linking part
45: reduced-diameter step part
46: securing means
5: main shaft operating part
50: front-end edge part
51: restricting protuberances
52: guide hole
53: guide groove
54: interlocking parts
6: lock control member
60: first circumferential holding frame part
61: first aeration through-hole
62: cylindrical wall
620: tapered surface
63: circular plate
7: lock member
8: connecting chamber guidance member
80: second circumferential holding frame part
81: second aeration through-hole
82: inner surface (inner surface of upright wall)
83: main shaft insertion part
84: circular base plate
9: linking part
90: linking-part-side valve body
91: locking groove part
92: distal end
93: inlet-linking-part-side passageway
s1: first seal member
s2: second seal member
s3: third seal member
s4: fourth seal member
s5: fifth seal member

What is claimed is:

1. A coupler for connecting a hose of a refrigerant loading/recovery source to a linking part in a heating/cooling device, the linking part having a linking-part-side valve body, the coupler comprising a connecting part capable of connecting at least with the linking part of the heating/cooling device, a main shaft capable of pressing the linking-part-side valve body of the heating/cooling device, and a main shaft operating part for moving the main shaft forward and backward; the coupler characterized in that:
restricting protuberances are provided to either a rear outside face of the connecting part or the main shaft operating part;
protuberance-guiding means for guiding the restricting protuberances are formed in the other one of the rear outside face of the connecting part and the main shaft operating part, along tracks that spiral around the center axis of the connecting part; and
the restricting protuberances are capable of moving within the protuberance-guiding means in a range of up to approximately 90° in a rear view about the center axis of the connecting part, and the main shaft operating part can be actuated relative to the connecting part within the same range of up to approximately 90°.

2. A coupler for connecting a hose of a refrigerant loading/recovery source to a linking part in a heating/cooling device, the linking part having a linking-part-side valve body, the coupler comprising a connecting part capable of connecting at least with the linking part of the heating/cooling device, a main shaft capable of pressing the linking-part-side valve body of the heating/cooling device, and a main shaft operating part for moving the main shaft forward and backward; the coupler characterized in that:
restricting protuberances are provided to either a rear outside face of the connecting part or the main shaft operating part;
protuberance-guiding means for guiding the restricting protuberances are formed in the other one of the rear outside face of the connecting part and the main shaft operating part, along tracks that spiral around the center axis of the connecting part; and
the restricting protuberances are capable of moving within the protuberance-guiding means in a range of up to approximately 90° in a rear view about the center axis of the connecting part, the main shaft operating part can be actuated relative to the connecting part within the same range of up to approximately 90°, interlocking parts are formed in open-side ends of the protuberance-guiding means so as to expand the groove width rearward, the restricting protuberances are configured to interlock with the interlocking parts, and a collision noise and shock accompanies the interlocking of the restricting protuberances and the interlocking parts.

3. The coupler according to claim 1, characterized in being provided with a connecting chamber guidance member and a lock control member with which the main shaft communicates in the connecting space of the connecting part, the lock control member being placed toward the front, the connecting chamber guidance member being placed toward the rear, a second spring member being provided therebetween, and, while the main shaft operating part is moved from the open state of the coupler to the blocked state, the retracting of the main shaft which moves in conjunction and the elastic force of the second spring member forming a gap between the lock control member and the connecting chamber guidance member and allowing residual gas in the connecting space to be expelled to the exterior.

4. The coupler according to claim 2, characterized in being provided with a connecting chamber guidance member and a lock control member with which the main shaft communicates in the connecting space of the connecting part, the lock control member being placed toward the front, the connecting chamber guidance member being placed toward the rear, a second spring member being provided therebetween, and, while the main shaft operating part is moved from the open state of the coupler to the blocked state, the retracting of the main shaft which moves in conjunction and the elastic force of the second spring member forming a gap between the lock control member and the connecting chamber guidance member and allowing residual gas in the connecting space to be expelled to the exterior.
